(19) United States
(12) Patent Application Publication
(10) Pub. No.: US 2006/0097695 A1
(43) Pub. Date: May 11, 2006

(54) Analog OR circuit with wide input voltage detection range

(76) Inventors: Sicheng Chen, College Station, TX (US); SiewKuok Hoon, Dallas, TX (US)

Correspondence Address: TEXAS INSTRUMENTS INCORPORATED, P O BOX 655474, M/S 3999, DALLAS, TX, 75265, US

(21) Appl. No.: 10/985,866

(22) Filed: Nov. 10, 2004

(51) Int. Cl. H02J 7/00

(52) U.S. Cl. 320/114

(57) ABSTRACT

An analog OR circuit selects from a plurality of input voltages to supply other circuits within a device, especially battery powered devices, such as portable telecommunications devices. A plurality of input circuits convert the input voltages to current signals which are averaged to generate a reference current signal. A comparison is made between the input current signals and the reference current signal to generate comparison signals which are output to a winner-takes-all circuit or a comparator for selecting the strongest input voltage signal.

### TECHNICAL FIELD OF THE INVENTION

This invention relates to an analog OR gate and more specifically to an analog OR gate for selecting battery power or battery charger power for circuits in a battery powered device, such as a cellular telephone.

### BACKGROUND OF THE INVENTION

High energy rechargeable batteries have enabled an explosion in small hand-held electronic devices such as cellular telephones, PDAs, and two-way messaging devices. In these devices, the charging circuit for the rechargeable battery is typically located outside of the device in order to avoid penalizing the device by the size, weight and heat generated by the charging circuit. A cable from the charging circuit will typically plug into a connector on the portable device. Power management circuits are an important part of these hand-held electronic devices in order to maximize the operating time of the device between battery charges. In addition, it is common to have a “fuel gauge” function which provides an indication of how much battery capacity remains.

FIG. 1 shows a circuit for monitoring power provided by the battery charger and the battery generally as 100. In this circuit, two resistors R₁ and R₂ are coupled between the battery charger voltage and a load 114. The battery voltage is connected between the two resistors. A first sense amplifier 102 is coupled across resistor R₁ at points 104 and 106 and provides an output to digital to analog converter (DAC) 116. A second sense amplifier 110 is coupled across Resistor R₂ at points 108 and 112 and provides an output to digital to analog converter 118. The circuits shown in FIG. 1 can provide the following necessary functions. The sense amplifier 102 senses the current from the charger so the power management circuit can provide necessary overcurrent load protection. In addition, the output of the sense amplifier 102 is coupled to the high resolution digital to analog converter 116 and is used to provide the “fuel gauge” function. When the charger is not on, the second sense amplifier 110 senses the maximum load current and activates the overcurrent load protection when necessary. It can also be utilized with the high-resolution digital to analog converter 118 to provide the “fuel gauge” function with an indication of how much power has been drawn from the battery. The sense amplifiers 102, 110 should be high-performance, high-gain instrumentation amplifiers because the analog voltage output will be fed to a high resolution digital to analog converter, for example, an 11 bit digital to analog converter. The output of the amplifier follows the differential equation A(V₁−V₂)+B, where A and B are constants.

One problem with this circuit, is which power supply should be utilized to provide the voltage VDD. The charge voltage is not available at all times, because the charger is not always on, so that the output voltage can vary from zero volts to 6.5 volts, for example. It is, therefore, not a good choice. The battery voltage (VBAT) may vary from 2.0 to 6.5 volts, for example. Utilizing the battery voltage would make having a circuit with a wide input voltage range difficult. Consider, for example, if the battery voltage is 3.0 V and if we plug in the charger, one input to the sense amplifier can see the battery voltage of 3.0 V while the other input can be as high as 6.5 V. A preferred sense amplifier configuration is the folded cascade NMOS input amplifier shown in FIG. 2 generally as 200. In FIG. 2, the two input voltages V₁ and V₂ are input to the gates of NMOS transistors 206 and 208, the sources of which are coupled to ground through current source 210. The drain of transistor 206 is coupled to the drain of PMOS transistor 202 and the drain of transistor 208 is coupled to the drain of PMOS transistor 204. The sources of transistors 202 and 204 are coupled to the voltage VDD and the gates thereof are connected to a biasing source VBIAS1. The junction of the sources for transistors 202 and 206 is connected to the source of PMOS transistor 212 and the junction between transistors 204 and 208 is connected to the source of PMOS transistor 214. The gates of transistors 212 and 214 are connected to a biasing source VBIAS2. The drain of transistor 212 is connected to diode connected NMOS transistor 216 and the drain of transistor of 214 is connected to the drain of NMOS transistor 218, the sources of both transistor are connected to ground. The gate of transistor 218 is connected to the gate of transistor 216. The drain of transistor 218 is also connected to the gate of NMOS 220. The source of transistor 220 is grounded and the drain is connected to the voltage source VDD through current source 222. The output of the circuit 224 is taken between the current source 222 and the drain of transistor 220. As is known to the skilled in the a art, such a wide range of input voltages to a sense amplifier circuit such as circuit 200, could easily saturate the sense amplifier and therefore compromise accuracy.

A solution to the problem is to select the highest voltage, that is the charger voltage or battery voltage and use that voltage as the supply voltage to the sense amplifiers. One simple solution is shown in FIGS. 3(a) and 3(b). In FIG. 3(a), two diode connected transistors Q₁ and Q₂ are connected to the two voltages sources V₁ and V₂ and the higher voltage will produce an output voltage V0 to power the circuit. The equivalent circuit is shown in FIG. 3(b) as two diodes D₁ and D₂. Although this is a simple solution, in deep submicron CMOS processes, a NPN bipolar transistor is not available. In addition, the output of voltage V0 is equal to the higher of the input voltages V₁ and V₂ minus the voltage drop V_{BE} of transistor Q₁ or Q₂. Thus, the output of voltage V0 is one diode voltage drop lower than the highest input voltage. This could still force the input differential pair of the instrumentation amplifier 200 to operate in the non-saturation region. To operate in a saturation region, the drain terminal of the input pair needs to be at most V_{T}(threshold voltage) below the gate voltage. The gate voltage here is either the battery voltage VBAT or the charger voltage VCHG and the drain terminal would be at VBAT or VCHG minus V_{BE} minus Vd_{SAT}, _{PMOS}, so that the input differential pair is likely to go out of saturation.

Another solution is to utilize two switches as shown in FIG. 4. The switches sw₁ and sw₂ are controlled by a comparator that compares the two voltages VBAT and VCHG. Two volt comparator are known in the art. However, even with this solution, we still run into the problem of which supply voltage to use for the comparator. For example, If V₁ is 3 volts and V₂ is 6 volts, and the VDD supply is 3 volts, then the input transistor of an NMOS differential pair would be completely cut off and fail to perform as a comparator. In addition, the comparator can only compare two inputs; if there are three more input voltages to be compared, multiple comparators are required.

### SUMMARY OF THE INVENTION

It is a general object of the present invention to provide an analog OR circuit.

This and other objects and features are provided, in accordance with one aspect of the present invention a analog OR circuit comprising: a plurality of input circuits, each input circuit comprising a voltage to current converter which generates an input current signal from an input voltage signal. An average current generator is coupled to each of the plurality of input circuits for generating a reference current signal which is an average of the input current signals. A comparison circuit compares each of the input current signals with the reference current signal to generate a plurality of comparison signals, one comparison signal being generated for each of the input current signals. A winner-takes-all circuit having a plurality of inputs, one input for receiving each of the comparison signals and generating an output signal for the selecting the strongest input voltage signal.

Another aspect of the invention includes a portable telecommunications device comprises a battery, and a connection to the battery for receiving a battery charger output voltage. A transceiver has an input and output device, the transceiver being coupled to the battery. An analog OR circuit selects either battery voltage or the battery charger output voltage as an operating voltage for at least one circuit in the portable telecommunications device.

A further aspect of the invention is provided by a method of selecting the operating voltage for a circuit in a portable telephone communications device. A battery voltage is converted into a first current signal the amplitude of which corresponds to the magnitude of the voltage. A battery charger output voltage is converted into a second current signal the amplitude of which corresponds to the magnitude of the voltage. A third current signal is generated which represents an average of the first and second current signals. The first and second current signals are compared to the third current signal, and one of the first and second comparisons is determined as being greater.

### BRIEF DESCRIPTION OF THE DRAWINGS

FIG. 1 shows a technique for providing current sense functions for a battery and battery charger powered circuit;

FIG. 2 shows a folded cascode NMOS amplifier for the operational amplifiers in FIG. 1;

FIG. 3(a) illustrates a prior art OR circuit;

FIG. 3(b) illustrates the equivalent circuit of FIG. 3(a);

FIG. 4 illustrates a two switch solution;

FIG. 5 shows an analog OR circuit according to the present invention;

FIG. 6(a) shows a switch suitable for use with the circuit of FIG. 5;

FIG. 6(b) shows a first embodiment of the switch shown in FIG. 6(a);

FIG. 6(c) shows a second embodiment of the switch shown in FIG. 6(a);

FIGS. 7(a) and 7(b) are simulations of the input and the output, respectively for the conventional diode OR gate and the present invention.

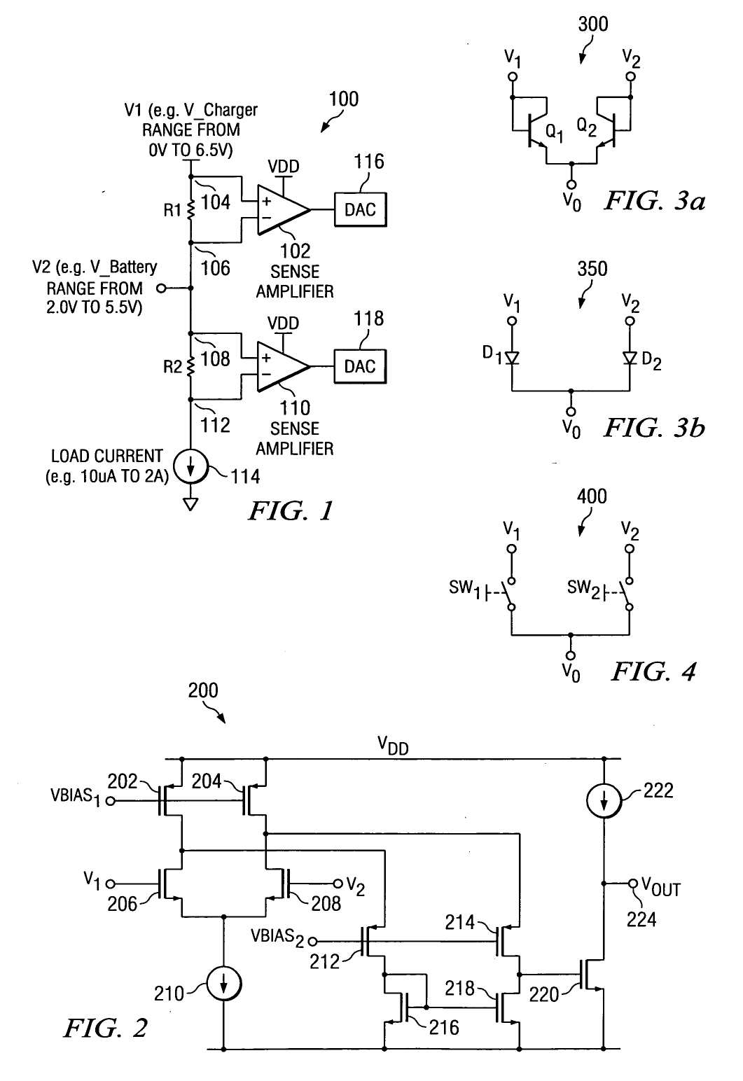

### DETAILED DESCRIPTION OF THE PRESENT INVENTION

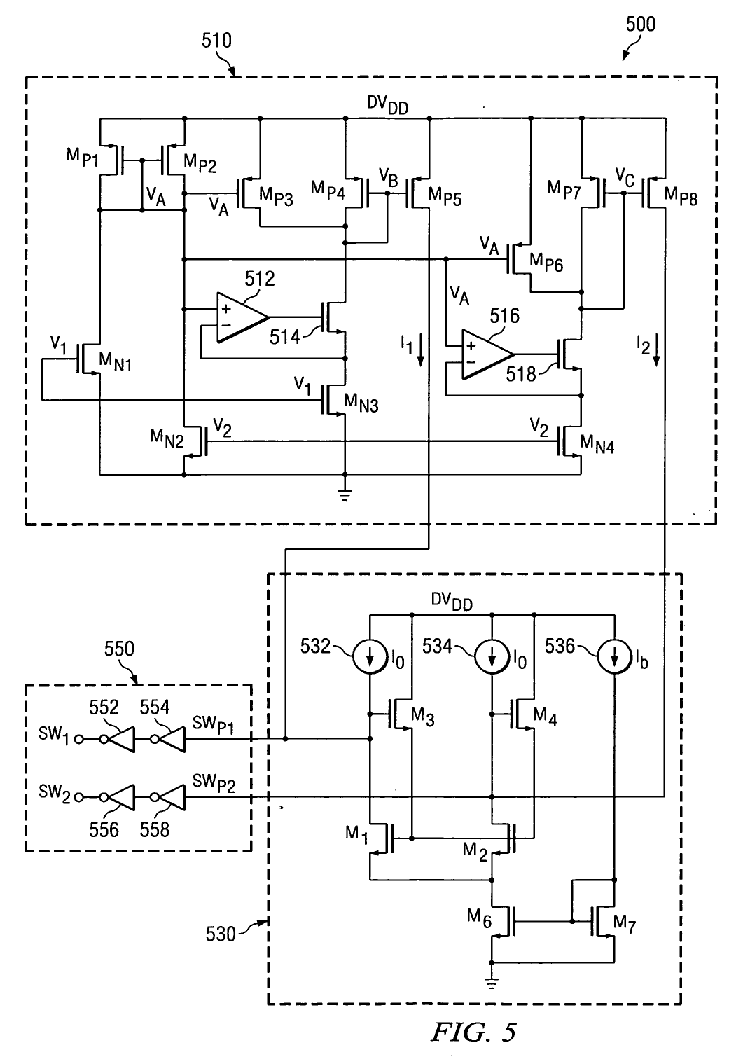

FIG. 5 is a schematic diagram of an analog OR circuit according to the present invention, shown generally as 500. In FIG. 5, block 510 is an input voltage to current circuit which generates a current circuit which generates a current proportional to the input voltages V₁ and V₂. An average of these two currents is generated and each current is compared to the average.

In FIG. 5, the sizes of the transistors are:
M_{P1}, M_{P2}, M_{P3}, and M_{P6}: (W/L)_{P1}. 1.
M_{P4} and M_{P7}: (W/L)_{P4} 2.
M_{P5} and M_{P8}: k(W/L)_{P4}. 3.
M_{N1}, M_{N2}, M_{N3} and M_{N4}: (W/L)_{N1}. 4.

The circuit shown as FIG. 5 comprises three blocks. Block 510 receives the input voltages V₁ and V₂ and converts them into current signals. The circuit generates a reference current signal which is the average of the two currents. It then compares the two input current signals with the reference current signal to generate comparison signals which with an output to the winner-takes-all circuit 530, which is a form of comparator. The outputs of the winner-takes-all circuit 530 are coupled to buffer circuit 550 which generates the output signals sw₁ and sw₂.

The circuit 510 has input signal V₁ coupled to the gate of NMOS transistors Mₙ₁ and Mₙ₃ and the signal V₂ coupled to the gate of NMOS transistors Mₙ₂ and Mₙ₄. The drain of transistor Mₙ₁ is coupled to the drain of PMOS transistor Mₚ₁, the source of which is connected to the voltage DVDD. The drain of transistor Mₙ₂ is connected to the drain of PMOS transistor Mp₂, the source of which is connected to DVDD. The gates of transistors Mp₁ and Mp₂ are connected together and this point is connected to the drains of each transistor. The drain of transistor Mp₂ is connected to the gate of a PMOS transistor Mp₃, the source of which is connected to DVDD. The drain of transistor Mp₃ is connected to the drain of a PMOS transistor Mₚ₄, the source of which is connected to DVDD. The drains of transistors Mp₃ and Mp₄ are connected to the drain of an NMOS transistor 514, the gate of which is connected to the drain of transistor Mp₂ via operational amplifier 512. The non-inverting input of amplifier 512 is connected to the drain of transistor Mp₂ and the inverting input is connected to the source of transistor 514. The source of transistor 514 is connected to the drain of NMOS transistor Mn₃, the source of which is connected to ground. The gate of transistor Mp₄ is connected to the gate of PMOS transistor Mp₅, the source of which is connected to DVDD. The gates of transistors Mp₄ and Mₚ₅ are connected to the drains of transistors Mp₃ and Mp₄. The drain of transistor Mp₅ is the first output I₁ to the block 530. The drain of transistor Mp₂ is also connected to the gate of PMOS transistor Mp₆, the source of which is connected to DVDD. The drain of transistor of Mp₆ is connected to the drain of PMOS transistor Mp₇, the source of which is connected to DVDD. The gate of transistor Mp₇ is connected to the gate of PMOS transistor Mp₈, the source of which is connected to DVDD. The drain of transistor Mp₈ is the second output I₂ of the circuit 510 to the circuit 530. The connected gates of transistors Mp₇ and Mp₈ are connected to the connected drains of transistors Mp₆ and Mp₇. This point is connected to the drain of an NMOS transistor 518, the gate of which is connected to the output of operational amplifier 516. The non-inverting input of operational amplifier 516 is connected to the gate voltage of transistor Mp₆. The inverting input of operational amplifier 516 is connected to the source of transistor 518 and to the drain of NMOS transistor Mₙ₄. The source of connector Mₙ₄ is connected to ground.

Block 530 is a winner-takes-all circuit comprising current sources 532, 534, 536 inserted between the voltage source DVDD and the gates of NMOS transistors M₃ and M₄ and the drain of NMOS transistor M₇. The drain of transistors M₃ and M₄ are connected to DVDD. The sources of transistors M₃ and M₄ are connected to the gate of NMOS transistor M₁, the drain of which is connected to the gate of transistor M₃. The drain of transistor M₇ is connected to the gate thereof and to the gate of NMOS transistor M₆. The drain of transistor M₆ is connected to the drain of transistor M₁. The drains of transistors M₆ and M₇ are connected to ground. The input signal from the drain of transistor Mₚ₅, which is current I₁, is connected to the gate of transistor of M₃. The signal generated at the drain of transistor Mₚ₈, current I₂, is connected to the drain of transistor M₂. Each form an output of the circuit 530.

The two outputs of circuit 530 are connected to buffer circuit 550. The first output is coupled to the current I₁ via two inverting buffer amplifiers 552, 554 to generate the signal sw₁. The second output is connected to the current I₂ via two inverting buffers 556, 558 to generate the signal sw₁.

The operation of the circuit in FIG. 5 is briefly as follows. For simplicity, the drain-source current in any transistor M_{X} is represented by I_{d}_{_{—}}_{X}. The drain voltages of M_{N3} and M_{N4} are forced to be V_{A} by the amplifiers 512 and 514.

$$Suppose$$

$${V}_{1} = {V}_{bat} = 4 V ;$$

$${V}_{2} = {V}_{charger} = 6 V ;$$

$$DVDD = 3 V ;$$

$$we have$$

$${I}_{d\_N1} < {I}_{d\_N2}$$

$$and$$

$${I}_{d\_P1} = \frac{1}{2} ( {I}_{d\_N1} + {I}_{d\_N2} ) .$$

Because all the terminal voltages and size are matched, the current of M_{N3} and M_{N4} equal to those of M_{N1} and M_{N2}, respectively. M_{P3} tries to source the same current as I_{d}_{_{—}}_{P1}, but since I_{d}_{_{—}}_{P1}>I_{d}_{_{—}}_{N3}=I_{d}_{_{—}}_{N1}, M_{P3} will enter the linear region and shut down M_{P4} and M_{P5}. Thus I₁=I_{d}_{_{—}}_{P4}=0. Since I_{d}_{_{—}}_{P6}<I_{d}_{_{—}}_{N4}, M_{P7} is turned on and I₂=kI_{d}_{_{—}}_{P7}>0. The current winner-take-all circuit 530 will pick out the maximum current I₂ and the buffer stage will generate the switch control signals.

A more detailed description of the operation of the circuit shown in FIG. 5 is as follows:

Since M_{N1} and M_{N2} are both in linear region, their drain-source currents are

$$\begin{matrix}{I}_{d\_N1} = {{KP}_{N} ( \frac{W}{L} )}_{N1} ( {V}_{1} - {V}_{T} - \frac{1}{2} {V}_{A} ) {V}_{A} & ( 1 ) \\ {I}_{d\_N2} = {{KP}_{N} ( \frac{W}{L} )}_{N1} ( {V}_{2} - {V}_{T} - \frac{1}{2} {V}_{A} ) {V}_{A} & ( 2 )\end{matrix}$$

where V_{A} is the drain voltage of M_{P1} and M_{N1}.

Transistors M_{P1} and M_{P2} are in saturation region and therefore their currents are:

$$\begin{matrix}{I}_{d\_P1} = {I}_{d\_P2} = \frac{1}{2} ( {I}_{d\_N1} + {I}_{d\_N2} ) \\ = {{KP}_{N} ( \frac{W}{L} )}_{N1} ( \frac{{V}_{1} + {V}_{2} - {V}_{A}}{2} - {V}_{T} ) {V}_{A}\end{matrix} \qquad ( 3 )$$

Also we have:

$${I}_{d\_P1} = {I}_{d\_P2} = \frac{1}{2} {{KP}_{P} ( \frac{W}{L} )}_{P1} {( {V}_{DVDD} - {V}_{A} - {V}_{T} )}^{2} \qquad ( 4 )$$

Now suppose that V₁<V₂, from (1) and (2), we have I_{d}_{_{—}}_{N1}<I_{d}_{_{—}}_{N2}. If M_{N3} is in saturation region, we will have

$${I}_{d\_N3} = {I}_{d\_N1} < \frac{{I}_{d\_N1} + {I}_{d\_N2}}{2} = {I}_{d\_P1} = {I}_{d\_P3} .$$

Therefore, V_{B} will move up until M_{P3} enters the linear region and I_{d}_{_{—}}_{N3} equals to I_{d}_{_{—}}_{P3}. As the result, M_{P4} and M_{P5} are cut off and I₁=0.

Also we have:

$$\begin{matrix}{I}_{d\_N4} = {I}_{d\_N2} , {I}_{d\_P6} = {I}_{d\_P2} & ( 5 ) \\ {I}_{d\_P7} = {I}_{d\_N4} - {I}_{d\_P6} = {I}_{d\_N2} - {I}_{d\_P2} = \frac{1}{2} {{KP}_{N} ( \frac{W}{L} )}_{N1} ( {V}_{2} - {V}_{1} ) {V}_{A} & ( 6 ) \\ {I}_{2} = {I}_{d\_P8} = {kI}_{d\_P7} = \frac{k}{2} KP \frac{W}{L} ( {V}_{2} - {V}_{1} ) {V}_{A} & ( 7 )\end{matrix}$$

where k is the ratio of M_{P8} and M_{P7}.
Therefore, we have:

$${V}_{1} < {V}_{2} ⇒ \{ \begin{matrix}{I}_{1} = 0 \\ {I}_{2} = \frac{k}{2} {{KP}_{N} ( \frac{W}{L} )}_{N1} ( {V}_{2} - {V}_{1} ) {V}_{A}\end{matrix} , \qquad ( 8 )$$

where V_{A} can be calculated using (3) and (4).

The next step is to use I₁ and I₂ to get the switching control signals. The circuit 530 is a two-input Lazzaro current mode winner-take-all (WTA) circuit. It operates by selecting the maximum input current. Suppose in the beginning, I₁=I₂=0. All the transistors in block 530 are in saturation region. Because M₁ and M₂ share the same gate to source voltage V_{g}, the drain voltages of M₁ and M₂ are equal. At time t, I₂ is no longer zero, and the drain voltage of M₂ will increase. Due to the source follower effect, V_{g} will increase. This increase of V_{g} reduces the gate-source voltage of M₃, thus reduce I_{d3}. As the sum of I_{d3} and I_{d4} equals to I_{B}, I_{d4} increases. This further increases the voltage of swₚ₂. If I₂ is large enough, only M₂ and M₄ are in the saturation region; M₁ goes into linear region and M₃ is cut off. Thus swₚ₁, will go to logic 0 and swₚ₂ goes to logic 1.

The block 550 is the buffer stage which converts the signals swₚ₁ and swₚ₂ to the output signals sw₁ and sw₂, respectively.

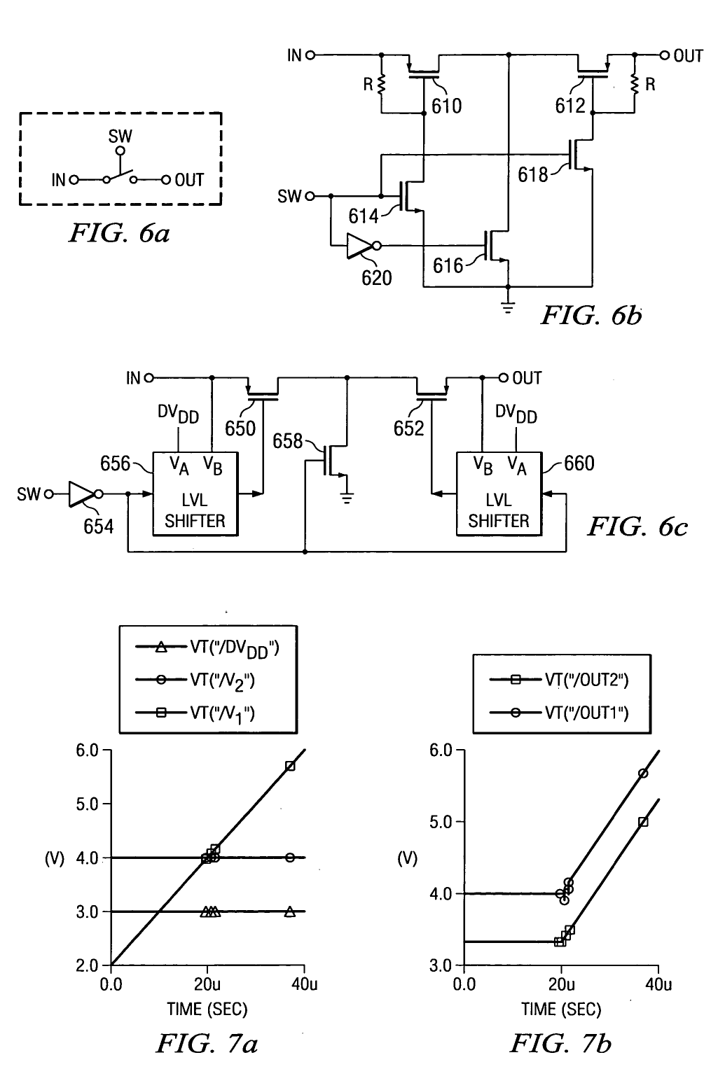

The switches used in the proposed circuit are shown in FIG. 6. FIG. 6(a) shows the switch that is to be implemented. FIG. 6(b) and FIG. 6(c) provide two ways to implement the switch. The benefit of FIG. 6(b) is its simple circuitry. However its relatively high current consumption may be a drawback for some applications. In FIG. 6b, the input signal is applied to a source of PMOS transistor 610, the gate of which is connected to the source via resistor R. The gate of transistor 610 is connected to the drain of NMOS transistor 614, the gate of which is connected to the signal sw. The source of transistor 614 is connected to ground. The signal sw is coupled to the gate of NMOS transistor 616 via inverter 620. The source of transistor 616 is connected to ground and the drain in connected to the drain of transistor 610. The signal sw is also coupled to the gate of NMOS transistor 618, the source of which is connected to ground. The drain of transistor 618 is connected to the gate of PMOS transistor 612, the source of which is connected to the output terminal and coupled to the gate thereof via a resistor R. FIG. 6(c) uses level shifters to boost up the voltages of the input signals. The shifter has two supply voltages Vₐ and V_{b} and its function is to shift the input logic level from Vₐ to V_{b}. Any conventional level shifter can be used. The input signal is connected to the source of PMOS transistor 650, which is also connected to the V_{b} input to the level shifters 656, The gate of transistor 650 is coupled to the output of level shifter 656. The voltage DVDD is connected to the Vₐ input to the level shifter 656 and the signal sw is coupled to the input of a level shifter 656 via inverter 654. The drain of transistor 650 is coupled to the drain of NMOS transistor 658, the source of which is connected to ground. The gate of transistor 658 is connected to the output of inverter 654. The drain of transistor 650 is also connected to the drain of PMOS transistor 652, the source of which is connected to the output terminal and to the V_{b} input to the level shifter 660. The output of the level shifter 660 is connected to the gate of transistor 652 and the Vₐ input to the level shifter is connected to the source of voltage DVDD. The input to the level shifter 660 is connected to the input of the level shifter 656 which is the output of inverter 654.

The simulation results in FIG. 7 prove that the proposed circuit has much better output range than that of conventional one. As shown in FIG. 7(a): DVDD and V₁ are 3V and 4V respectively; V₂ is a ramp signal that rises from 2V to 6V in 40us. FIG. 7(b) shows the output (‘out2’) of the conventional diode OR gate and the output (‘out’) of the proposed circuit. We can see that ‘out2’ is always about 0.7V lower than Max{V₁,V₂} and ‘out’ is very close to Max{V₁,V₂}. The small glitch in FIG. 7(b) happens when the switches are turned on or off, which is not critical issue and can be removed by adding a small capacitor, if necessary.

While the invention has been shown and described with reference to preferred embodiments thereof, it is well understood by those skilled in the art that various changes and modifications can be made in the invention without departing from the spirit and scope of the invention as defined by the appended claims. For example, in FIG. 5(a) the current consumption in real applications can be limited by weakening M_{N1}, M_{N2}, M_{N3}, and M_{N4} by connecting serial resistors to their sources. Furthermore, in the derivation, V₁ and V₂ are greater than DVDD, this is not a requirement of the present invention. This circuit is still useful in the case where V₁ and V₂ are lower than DVDD. Furthermore, the circuit can easily be extended to multiple inputs because the winner-takes-all circuit can accept multiple inputs in place of the two input illustrated herein.

1. An analog OR circuit comprising:
a plurality of input circuits, each input circuit comprising a voltage to current converter which generates an input current signal from an input voltage signal;
an average current generator coupled to each of the plurality of input circuits for generating a reference current signal which is an average of the input current signals;
a comparison circuit which compares each of the input current signals with the reference current signal to generate a plurality of comparison signals, one comparison signal being generated for each of the input current signals; and
a winner-takes-all circuit having a plurality of inputs, one input for receiving each of the comparison signals and generating an output signal for the selecting the strongest input voltage signal.

2. The analog OR circuit of claim 1 further comprising a plurality of switches, one switch for each of the plurality of input voltage signals, the plurality of switches selecting the input voltage signal having the greatest amplitude for powering another circuit.

3. The analog OR circuit of claim 2 further comprising a plurality of output buffer circuits, one buffer circuit for each of the plurality of switches each being coupled between an output of the winner-takes-all circuit and a control input to one of the switches.

4. The analog OR circuit of claim 1 wherein the winner-takes-all circuit is a comparator.

5. In a cellular telephone, an analog OR circuit for selecting either a battery voltage or a battery charger voltage as an operating voltage for circuits in the cellular telephone comprising:
a first input circuit coupled to the battery voltage for generating a first output current signal corresponding to the magnitude of the battery voltage;
a second input circuit coupled to the battery charger voltage for generating a second output current signal corresponding to the magnitude of the battery charger voltage;
an average current generator coupled to the first and second input circuits for generating a reference current signal which is an average of the first and second output current signals;
a comparison circuit which compares the first and second output current signals with the reference current signal to generate first and second comparison signals; and
a winner-takes-all circuit coupled to the comparison circuit and responsive to the first and second comparison signals and generating a selection signal for selecting the input voltage signal having the greater magnitude.

6. The analog OR circuit of claim 5 further comprising a first switch coupled between the battery and a circuit in the cellular telephone;
a second switch coupled between the connection to the battery charger voltage and the circuit in the cellular telephone, the first and second switches being coupled to the winner-takes-all circuit for selecting a power source for the circuit.

7. The analog OR circuit of claim 6 further comprising a first buffer circuit coupled between a first output of the winner-takes-all circuit and the first switch; and
a second buffer circuit coupled between a second output of the winner-takes-all circuit and the second switch.

8. The analog OR circuit of claim 6 wherein the winner-takes-all circuit is a comparator.

9. A portable telecommunications device comprising:
a battery;
a connection to the battery for receiving a battery charger output voltage;
a transceiver having an input and output device, the transceiver being coupled to the battery; and
an analog OR circuit for selecting either battery voltage or the battery charger output voltage as an operating voltage for at least one circuit in the portable telecommunications device.

10. The portable telecommunications device of claim 9 further comprising a first switch coupled between the battery and a circuit in the portable telecommunications device;
a second switch coupled between the connection to the battery charger voltage and the circuit in the portable telecommunications device, the first and second switches being coupled to the winner-takes-all circuit for selecting a power source for the circuit.

11. The portable telecommunications device of claim 10 further comprising a first buffer circuit coupled between a first output of the winner-takes-all circuit and the first switch;
and a second buffer circuit coupled between a second output of the winner-takes-all circuit and the second switch.

12. The portable telecommunications device of claim 9 wherein the portable telecommunications device is a cellular telephone.

13. The portable telecommunications device of claim 10 wherein the portable telecommunications device is a cellular telephone.

14. The portable telecommunications device of claim 11 wherein the portable telecommunications device is a cellular telephone.

15. A method of selecting the operating voltage for a circuit in a portable telephone communications device comprising:
converting a battery voltage into a first current signal the amplitude of which corresponds to the magnitude of the voltage;
converting a battery charger output voltage into a second current signal the amplitude of which corresponds to the magnitude of the voltage;
generating a third current signal which represents an average of the first and second current signals;
comparing the first and second current signals to the third current signal; and
determining which of the first and second comparisons is greater.

16. The method of claim 15 further comprising switching the battery voltage or the battery charger output voltage, whichever has a higher voltage, to power a circuit in the portable telecommunications device.

17. The method of claim 15 wherein the portable telecommunications device is a cellular telephone.

18. The method of claim 16 wherein the portable telecommunications device is a cellular telephone.

19. The method of claim 15 wherein the determination is made by a comparator.
